(19) United States
(12) Patent Application Publication
(10) Pub. No.: US 2016/0139340 A1
(43) Pub. Date: May 19, 2016

(54) MEMS FIBER OPTICAL SWITCH

(71) Applicant: OPLINK COMMUNICATIONS, INC., Fremont, CA (US)

(72) Inventors: Jian ZHOU, Zhuhai, Guangdong (CN); Jun LI, Zhuhai, Guangdong (CN); Zhidong LIU, Zhuhai, Guangdong (CN); Kesheng XU, San Ramon, CA (US); Pei ZHU, Zhuhai, Guangdong (CN)

(73) Assignee: Oplink Communications, Inc., Fremont, CA (US)

(21) Appl. No.: 14/900,420

(22) PCT Filed: Jun. 27, 2013
(86) PCT No.: PCT/CN2013/078147

§ 371 Date: Dec. 21, 2015

(51) Int. Cl. G02B 6/35; G02B 6/40; G02B 6/32

(52) U.S. Cl. CPC G02B 6/3518; G02B 6/32; G02B 6/403; G02B 6/3546; G02B 6/357; G02B 6/359

(57) ABSTRACT

Methods, systems, and apparatus, including computer programs encoded on computer storage media, for optical switching. One of the optical switches includes a plurality of optical fibers positioned in an array, the plurality of fibers including one or more input fibers and a plurality of output fibers; a microelectromechanical (MEMS) mirror configured to controllably reflect light from an input fiber to a particular target output fiber of the plurality of output fibers, wherein a position of the MEMS mirror is controllable to switch from a first target output fiber to a second target output fiber of the plurality of output fibers, and wherein the position of the MEMS mirror is controlled using a vertically staggered comb drive.

### BACKGROUND

This specification relates to optical communications.

An optical switch is a switch that enables optical signals of one or more input optical fibers to be selectively switched to one of multiple output optical fibers or reciprocally switching from multiple input fibers to a common output fiber. Conventional optical switches can implement switching using various structures including mechanical, electro-optic, or magneto-optic switching.

### SUMMARY

In general, one innovative aspect of the subject matter described in this specification can be embodied in optical switches that include multiple optical fibers positioned in an array, the multiple fibers including one or more input fibers and multiple output fibers; a microelectromechanical (MEMS) mirror configured to controllably reflect light from an input fiber to a particular target output fiber of the multiple output fibers, wherein a position of the MEMS mirror is controllable to switch from a first target output fiber to a second target output fiber of the multiple output fibers, and wherein the position of the MEMS mirror is controlled using a multiple vertically staggered comb drive.

The foregoing and other embodiments can each optionally include one or more of the following features, alone or in combination. The mirror is controlled to provide a switch trajectory from the first target output fiber to the second target output fiber that does not traverse over any other fiber of the multiple fibers. The MEMS mirror includes two axes and wherein each axis can rotate in both clockwise and counterclockwise directions in order to rotate the MEMS mirror in both positive and negative x and y coordinate directions. The axes are structured such that the second axis is positioned within a structure of the first axis such that the first axis rotates together with the second axis structure as a whole and the second axis can rotate independently. A particular vertically staggered comb drive actuator includes upper comb electrodes and lower comb electrodes, wherein the upper and lower electrodes are distributed in upper and lower space relative to such that when a potential difference is applied between the upper and lower comb electrodes a force draws the upper and lower comb electrodes together causing a corresponding rotation of the MEMS mirror along a particular axis. The vertically staggered comb drive actuators are selectively driven to change an angular position of the MEMS mirror such that light reflected from the MEMS mirror is directed to the second target output fiber. The multiple optical fibers are positioned within a ferrule. The optical switch further includes a lens positioned between the multiple optical fibers and the MEMS mirror. The optical switch further includes a control circuit for controlling the MEMS mirror.

In general, one innovative aspect of the subject matter described in this specification can be embodied in optical switches that include a multiple optical fibers positioned in an array, the multiple fibers including one or more input fibers and multiple output fibers; a microelectromechanical (MEMS) mirror configured to controllably reflect light from an input fiber to a particular target output fiber of the multiple output fibers, wherein a position of the MEMS mirror is controllable to switch from a first target output fiber to a second target output fiber of the multiple output fibers, and wherein the position of the MEMS mirror is controlled using multiple bimorph suspension arms coupled to the MEMS mirror.

The foregoing and other embodiments can each optionally include one or more of the following features, alone or in combination. The MEMS mirror is rotated along a +x, −x, +y, or −y axis based on deformation of particular suspension arms. Each suspension arm comprises bimorph materials having different thermal expansion coefficients and wherein the distortion of a suspension arm is caused by applying an electric current through the suspension arm to heat the bimorph materials. Each suspension arm comprises a double S folding structure of bimorph material. The MEMS mirror is controlled by four pairs of suspension arms which provide four directional rotation of the MEMS mirror along the +/−x and +/−y axes. The MEMS mirror includes a second driving mechanism to form a hybrid driving mechanism, wherein the second driving mechanism is electrostatic or piezoelectric.

Particular embodiments of the subject matter described in this specification can be implemented so as to realize one or more of the following advantages. Driving a MEMS mirror using a vertical staggered comb actuator reduces driving voltage, provides a larger rotation angle, and has higher stability as compared to a conventional interdigitated comb actuator MEMS mirror. Driving a MEMS mirror using electric current heating of a bimorph material reduces driving voltage, reduces sensitivity to electric static charge, and provides a larger rotation angle as compared to a conventional interdigitated comb actuator MEMS mirror. The larger rotation angle allows the switch to have a greater number of output fibers. In particular, the MEMS mirrors rotate in ±x, ±y, which provides four directions of controlled rotation. This reduces the driving voltage required to cover the same angular range or allows for the same driving voltage to cover twice the rotational angular range. The lower driving voltage can result in a lower cost MEMS optical switch. Additionally, stability of the MEMS optical switch can be improved over conventional MEMS optical switches.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example MEMS optical switch.

FIG. 2 is an example fiber array.

FIG. 3 is an example MEMS switching system.

FIG. 4 is an example MEMS micro mirror chip.

FIG. 5 is an example perspective view of a vertically staggered comb drive MEMS mirror.

FIG. 6 is an example bimorph structure.

FIG. 7 is an example suspension arm formed from using a bimorph structure.

FIG. 8 is an example MEMS micro mirror chip using suspension arms.

FIG. 9 is an example switch package.

Like reference numbers and designations in the various drawings indicate like elements.

### DETAILED DESCRIPTION

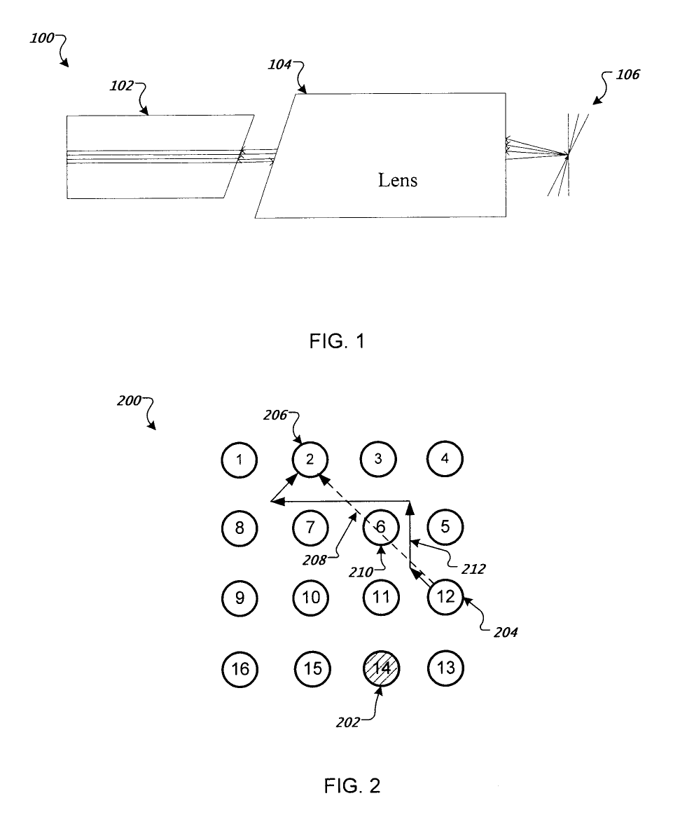

FIG. 1 is an example MEMS optical switch 100. The MEMS optical switch 100 includes multiple optical fibers held in a ferrule 102, a lens 104, and a MEMS mirror 106.

The multiple optical fibers can be fiber pigtails arranged in an N×M array. The array can be rectangular or positioned another suitable configuration. The fiber pigtails can be divided into two groups. A first group of fiber pigtails are used as an input fiber while the second group of fiber pigtails corresponds to output fibers. In some implementations, one or more of the multiple optical fibers can be unused fibers.

The lens 104 collimates light signals received from the input fibers and collimates reflected light signals from the MEMS mirror 106 and directs the reflected light signals to a particular output fiber. Light from an input fiber can be selectively directed to any output fiber forming a 1×L optical switch where L is the number of output fibers in the N×M array. Similarly, the same structure can be used to form an L×1 MEMS optical switch in which light from multiple input fibers are routed to an output fiber.

The MEMS mirror 106 can rotate to specific positions in response to control signals (e.g., particular applied voltages as described in greater detail below). For example, the MEMS mirror 106 includes an actuator used to drive a rotation of the mirror surface along x and y axes independently within a specified angular degree range. An input light beam that is incident on the mirror surface will be reflected through the lens 104 where it is focused on a particular output fiber depending on the x and y angular positions of the MEMS mirror 106. Example actuators used to drive a MEMS mirror such as MEMS mirror 106 are described in detail below.

FIG. 2 is an example fiber array 200. The fiber array 200 is a 4×4 rectangular arrangement. The fibers can be pigtails positioned within a ferrule. Each fiber is numbered from 1 to 16. In general, one or more of the fibers can be input fibers while other fibers are output fibers. For example, fibers 1-12 can be selectable output fibers. Additionally, in some implementations, there can be one or more unused fibers in the fiber array 200.

In this example, the fibers include an input fiber 202 and a first output fiber 204. Thus, a light beam input from fiber 202 is reflected by the MEMS mirror surface (e.g., surface of MEMS mirror 106 of FIG. 1) and directed to the first output fiber 204. Additionally, the example fiber array 200 shows a second output fiber 206. In response to a command, the input light beam from input fiber 202 can be switched from the first output fiber 204 to the second output fiber 206. To perform the switching, the x and y angular positions of the MEMS mirror are modified so that the input light beam is focused on the location of the second output fiber 206 instead of the location of the first output fiber 204. Although an example of a rectangular array is shown, other fiber configurations can be used. In some implementations, other geometric arrangements can be used as long as an input fiber is an edge fiber of the array.

In some implementations, the switching is performed by changing the x and y angular positions of the MEMS mirror directly using the shortest amount of angular movement to the mirror surface necessary to shift the light beam to the target output fiber. For example, the reflected light beam can traverse a straight line from the first output fiber 204 to the second output fiber 206 as the MEMS mirror is adjusted. However, such an implementation often results in “hitting” of unintended optical fibers. Hitting refers to at least a portion of the light beam, either directly or through refraction, leaking into an optical fiber that is not the target output fiber. For example, referring to the fiber array 200, one switch trajectory from the first output fiber 204 to the second output fiber 206 is shown by dashed line 208. However, this switch trajectory causes the light beam to pass across output fiber 210 as the light beam traverses from being directed to the first output fiber 204 to being directed to the second output fiber 206. This leaking of the light beam into the unintended optical fiber results in the fiber 210 being referred to as “hit.”

In some other implementations, the path from the first output port 204 to the second output port 206 is controlled to avoid light leakage into unintended optical fibers. The switch trajectory of the light beam is controlled such that it passes through a clearance space between any two fibers and/or completely outside of the range of any fibers and therefore avoids a hit to any unintended port. In particular, as shown by path 212, the x and y angular rotation positions of the MEMS mirror are controlled to follow a switching trajectory, having a number of discrete path segments, that avoids other optical fibers along the switch trajectory from the first output fiber 204 to the second output fiber 206.

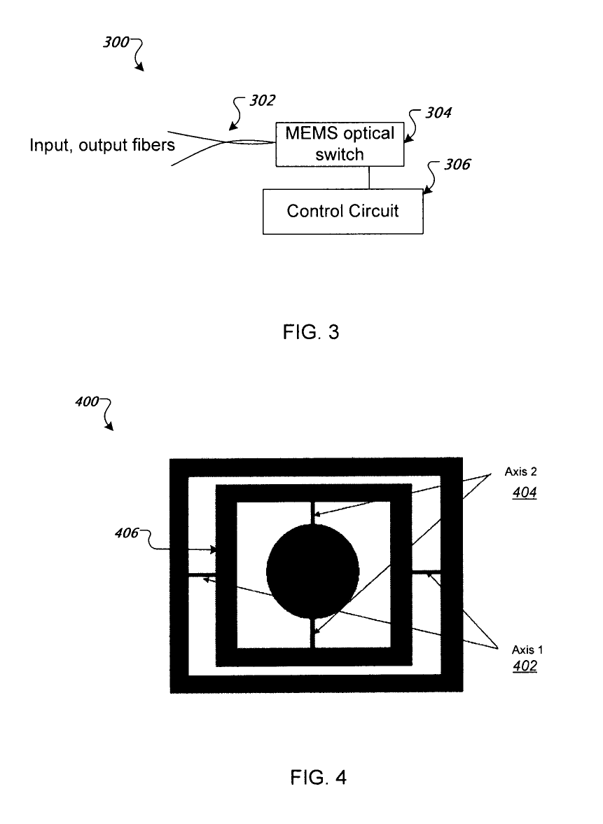

FIG. 3 is an example MEMS switching system 300. The MEMS switching system 300 include input and output fibers 302, a MEMS optical switch 304, and a control circuit 306. The MEMS optical switch 304 can be implemented as described above with respect to FIGS. 1-2. The input and output fibers 302 provide the input and output paths, respectively, for the fiber pigtails of the MEMS optical switch 304. The control circuit 306 can include input to switch between output fibers and send control signals to one or more mirror actuators. For example, the control circuit 306 can include voltage calibration data and switching trajectory data for points of the fiber array in the MEMS optical switch 304. The calibration and switching trajectory data including intermediate points positioned between output fibers. Thus, the control circuit 306 can provide appropriate switching signals to the MEMS mirror for accurately switching between output ports.

FIG. 4 is an example MEMS micro mirror chip 400. The MEMS micro mirror chip 400 includes a first axis 402 and a second axis 404. The first axis 402 provides for rotation of the MEMS micro mirror chip 400 relative to the first axis 402, e.g., an x axis. In particular, the first axis 402 is coupled to a first structure 406 of the MEMS micro mirror chip 400. Within the first structure 406 is the second axis 404, e.g., a y axis. The second axis 404 provides for rotation of the MEMS micro mirror chip 400 relative to the second axis 404. Rotation of the first axis 402 therefore also rotates the first structure 406 including the second axis 404. The second axis 404 can rotate independent of the first axis. In the example the MEMS micro mirror chip 400, the first axis 402 and the second axis 404 are orthogonal.

Each of the first axis 402 and the second axis 404 can rotate clockwise and counterclockwise about the axis by a specified rotational angle. This provide for +/−x and +/−y coordinate directions. As a result, the MEMS micro mirror chip 400 can rotate in four directions: +x, −x, +y, and −y.

In some implementations, to switch an input light incident on the mirror surface of the MEMS micro mirror chip 400 from a first output fiber to a second output fiber, control signals are received that cause the MEMS micro mirror chip 400 to rotate about the first axis 402 and/or the second axis 404 by particular amounts such that when the rotation is complete the input light incident on the mirror surface is reflected such that it is incident on the second output fiber. In particular, the driving force for each axis can be provided by a vertical staggered comb drive actuator.

A vertically staggered comb drive actuator is a type of electrostatic actuator. A vertical comb drive is used to provide out of plane actuation, e.g., rotation instead of in plane translation. The vertically staggered comb drive actuator includes a static comb and a mobile comb. The static comb is vertically displaced relative to the mobile comb such that a stack of two levels is generated corresponding to the respective combs. When a potential is applied between the mobile comb and the static comb, the mobile comb is drawn toward the static comb. When the mobile comb is fixed to a pivot, the mobile comb can provide rotational actuation as it is drawn to the static comb.

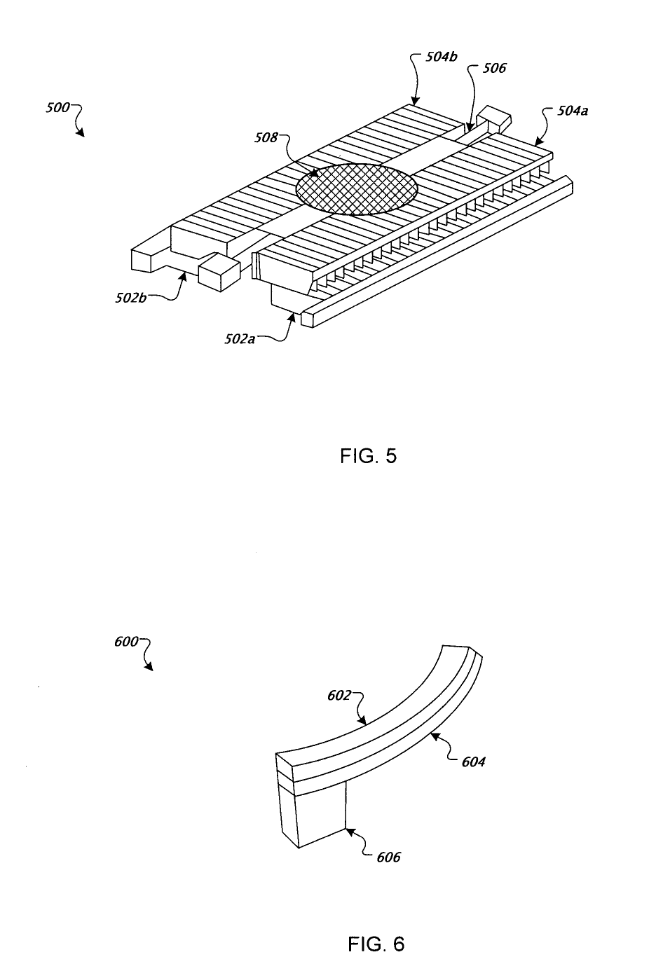

FIG. 5 is an example perspective view of a single axis vertically staggered comb drive actuator 500. The actuator 500 includes fixed lower comb finger 502a and 502b, movable upper comb fingers 504a and 504b, hinge 506 and MEMS micro mirror 508. For example, the actuator 500 can correspond to the actuator about the second axis 404 of FIG. 4. In response to a potential applied to a particular pair of upper and lower comb fingers, the MEMS micro mirror 508 will rotate about the hinge 506. For example, application of a potential between upper comb fingers 504a and lower comb finger 502a can cause a rotation about the hinge 506 in a positive direction (e.g., clockwise) while application of a potential between upper comb fingers 504b and lower comb finger 502b can cause a rotation about the hinge 506 in a negative direction (e.g., counterclockwise). As a result, the degree or rotation of the MEMS micro mirror 508 in either the positive or negative direction around the axis formed by the hinge can be controlled.

Additional actuators can be used to control the rotation about another axis. Thus, for example, one or more actuators can be associated with a particular axis of a MEMS micro mirror chip. For example, the first axis 402 or second axis 404 shown in FIG. 4. For a first actuator, application of a potential between a first pair of a static comb and a mobile comb can cause a rotation of the of the MEMS micro mirror chip about the first axis in the positive, e.g., clockwise, direction. Similarly, application of a corresponding potential between a second static comb and a mobile comb can cause a rotation of the MEMS micro mirror chip about the first axis in the negative, e.g., counterclockwise, direction. Similar vertically staggered comb drive actuators can be used to drive a rotation about the second axis in the positive and negative direction, respectively.

These actuators can be used to control a MEMS micro mirror's rotational position in to provide optical fiber switching. For example, an input signal from an input fiber can be switched from a first output fiber to a second output fiber by changing the MEMS micro mirror angular position. Light incident on the MEMS micro mirror from the input fiber is reflected to the designated output fiber. Potentials applied to particular vertically staggered comb drive actuators can change the position of the MEMS micro mirror along one or more axes in order to change the reflection of the light signal to the switched output fiber.

In some implementations, actuation of the MEMS micro mirror chip is driven using bimorph materials. FIG. 6 is an example bimorph structure 600. The bimorph structure 600 is formed from two materials, with different thermal expansion coefficients, stacked together. Thus, when heated, for example using an electric current, the bimorph structure 600 bends based on the respective coefficients of thermal expansion for the two materials. In the example bimorph structure 600, a first material 602 is silicon dioxide and the second material 604 is aluminum. The first material 602 and second material 604 can be placed in a block of silicon for mounting the bimorph structure to, e.g., an electrical contact. This bimorph structure can be the basis of a suspension arm for controlling rotations for a MEMS micro mirror chip.

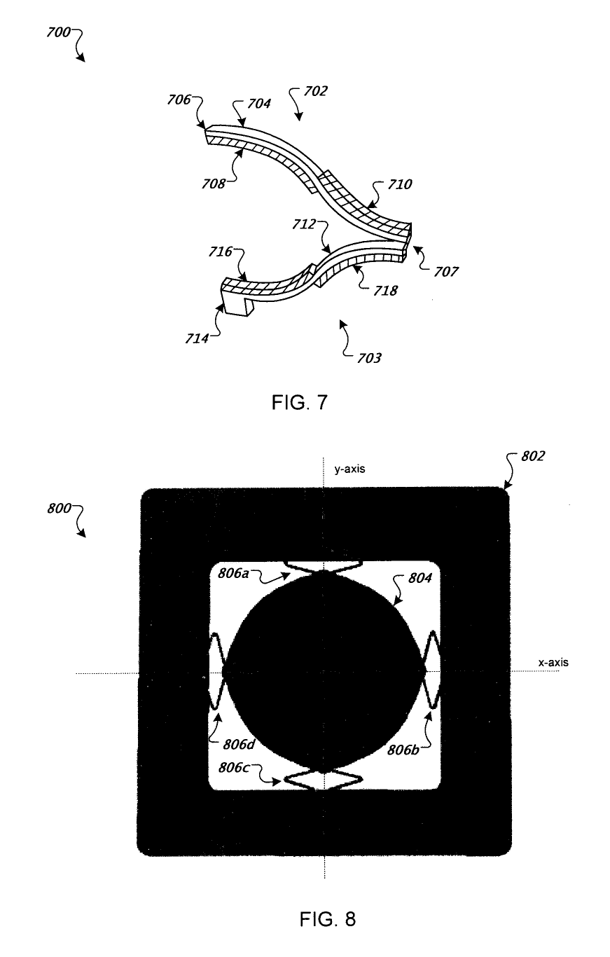

FIG. 7 is an example suspension arm 700 formed from using a bimorph structure. The suspension arm 700 is structured as a double “S” folding suspension arm. For convenience, the suspension arm 700 will be described with respect to an upper portion 702 and a lower portion 703.

The upper portion 702 includes a first curved portion 704 formed from a first material that extends from a first endpoint 706 to a folding point 707. The first curved portion 702 can be formed, for example, from aluminum. The first endpoint 706 can be attached to a MEMS micro mirror chip to rotate the MEMS micro mirror chip in about a particular axis.

To provide a bimorph structure, a first segment 708 and a second segment 710 formed from a second material are positioned relative to the first curved portion 704. In particular, the first segment 708 is positioned on an interior surface of the first curved portion 704 (relative to the lower portion 703) while the second segment 710 is positioned on an exterior surface of the first curved portion 704. The particular arrangement of materials and curved structure can be optimized to maintain deformation in a particular direction when the suspension arm 700 is heated. The first segment 708 and the second segment 710 can be formed, for example, from silicon dioxide.

The lower portion 703 includes a second curved portion 712 formed from the first material that extends from a second endpoint 714 to the folding point 707. The second curved portion 712 can be formed, for example, from aluminum. The second endpoint 714 can included a block, e.g., of silicon, for mounting the suspension arm 700 to a base material and can include one or more electrical contacts.

To provide a bimorph structure, a third segment 716 and a fourth segment 718 formed from the second material are positioned relative to the second curved portion 712. In particular, the third segment 716 is positioned on an interior surface of the second curved portion 712 (relative to the upper portion 702) while the fourth segment 718 is positioned on an exterior surface of the second curved portion 72. The third segment 716 and the fourth segment 718 can be formed, for example, from silicon dioxide.

When electric current passes through the suspension arm 700, the temperature rises and the arm deforms based on the respective thermal expansion coefficients of the first and second materials and the amount of deformation depends on the structure and arrangement of materials on the suspension arm 700. In particular, the design of the suspension arm 700 can deform to generate a vertical displacement that causes a MEMS micro mirror to rotate without generating lateral displacement. The deformation of the suspension with respect to applied current may not be linear. Therefore, particular calibration can be performed to determining a mirror rotation vs. current curve.

FIG. 8 is an example MEMS micro mirror chip structure 800 using suspension arms. The MEMS micro mirror chip structure 800 includes an outer frame 802, a micro mirror chip 804, and four pairs of suspension arms 806a-d. Each suspension arm can be similar to the suspension arm 700 of FIG. 7.

An electrical current can be selectively applied to one or more pairs of suspension arms 806 to cause a rotation of the micro mirror 804 along one or more axis in the +/−direction. In particular, each pair of suspension arms 806a-d is oriented to provide a rotation of the micro mirror chip 804 in a particular direction about an axis when heated by an electric current. For example, suspension arms 806a can be used to provide a rotation about the x-axis in a positive direction while suspension arms 806c can be used to provide a rotation about the x-axis in the negative direction. Similarly, suspension arms 806d can be used to provide a rotation about the y-axis in a positive direction while suspension arms 806b can be used to provide a rotation about the y-axis in the negative direction.

Thus, the micro mirror chip 804 can be rotated in four directions, +x, −x, +y, and −y based on application of current to particular pairs of suspension arms 806a-d. For example, to switch an incoming light beam from a first output fiber to a second output fiber, the mirror surface of the micro mirror chip may need to be rotated along the +x axis and the −y axis by a specified amount. An electric current can be provided to suspension arms 806a to drive a +x axis rotation and an electric current can be provided to suspension arms 806b to drive a −y axis rotation.

These suspension arm actuators can be used to control a MEMS micro mirror's rotational position in to provide optical fiber switching. For example, an input signal from an input fiber can be switched from a first output fiber to a second output fiber by changing the MEMS micro mirror angular position. Light incident on the MEMS micro mirror from the input fiber is reflected to the designated output fiber. Electric current applied to particular suspension arms can change the position of the MEMS micro mirror along one or more axes in order to change the reflection of the light signal to the switched output fiber.

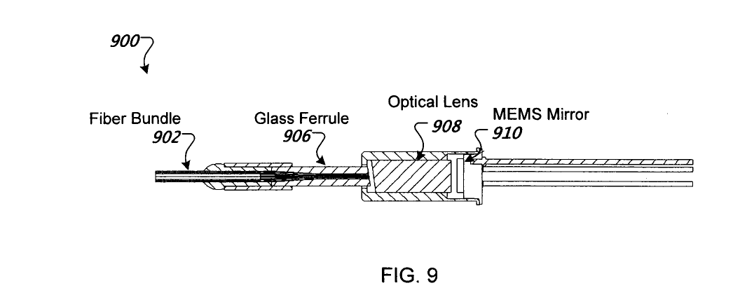

FIG. 9 is an example switch package 900. The switch package 900 includes a fiber bundle 902, a fiber pigtail including a glass ferrule 906, an optical lens 908, and a MEMS mirror 910. The switch package 900 can be coupled to an optical fiber bundle in an optical communications system.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. An optical switch comprising:
a plurality of optical fibers positioned in an array, the plurality of fibers including one or more input fibers and a plurality of output fibers;
a microelectromechanical (MEMS) mirror configured to controllably reflect light from an input fiber to a particular target output fiber of the plurality of output fibers, wherein a position of the MEMS mirror is controllable to switch from a first target output fiber to a second target output fiber of the plurality of output fibers, and wherein the position of the MEMS mirror is controlled using a plurality of vertically staggered comb drive.

2. The optical switch of claim 1, wherein the mirror is controlled to provide a switch trajectory from the first target output fiber to the second target output fiber that does not traverse over any other fiber of the plurality of fibers.

3. The optical switch of claim 1, wherein the MEMS mirror includes two axes and wherein each axis can rotate in both clockwise and counterclockwise directions in order to rotate the MEMS mirror in both positive and negative x and y coordinate directions.

4. The optical switch of claim 2, wherein the axes are structured such that the second axis is positioned within a structure of the first axis such that the first axis rotates together with the second axis structure as a whole and the second axis can rotate independently.

5. The optical switch of claim 1, wherein a particular vertically staggered comb drive actuator includes upper comb electrodes and lower comb electrodes, wherein the upper and lower electrodes are distributed in upper and lower space relative to such that when a potential difference is applied between the upper and lower comb electrodes a force draws the upper and lower comb electrodes together causing a corresponding rotation of the MEMS mirror along a particular axis.

6. The optical switch of claim 4, wherein, the vertically staggered comb drive actuators are selectively driven to change an angular position of the MEMS mirror such that light reflected from the MEMS mirror is directed to the second target output fiber.

7. The optical switch of claim 1, wherein the plurality of optical fibers are positioned within a ferrule.

8. The optical switch of claim 1, further comprising a lens positioned between the plurality of optical fibers and the MEMS mirror.

9. The optical switch of claim 1, further comprising a control circuit for controlling the MEMS mirror.

10. An optical switch comprising:
a plurality of optical fibers positioned in an array, the plurality of fibers including one or more input fibers and a plurality of output fibers;
a microelectromechanical (MEMS) mirror configured to controllably reflect light from an input fiber to a particular target output fiber of the plurality of output fibers, wherein a position of the MEMS mirror is controllable to switch from a first target output fiber to a second target output fiber of the plurality of output fibers, and wherein the position of the MEMS mirror is controlled using a plurality of bimorph suspension arms coupled to the MEMS mirror.

11. The optical switch of claim 10, wherein the MEMS mirror is rotated along a +x, −x, +y, or −y axis based on deformation of particular suspension arms.

12. The optical switch of claim 11, wherein each suspension arm comprises bimorph materials having different thermal expansion coefficients and wherein the distortion of a suspension arm is caused by applying an electric current through the suspension arm to heat the bimorph materials.

13. The optical switch of claim 11, wherein each suspension arm comprises a double S folding structure of bimorph material.

14. The optical switch of claim 11, wherein the MEMS mirror is controlled by four pairs of suspension arms which provide four directional rotation of the MEMS mirror along the +/−x and y axes.

15. The optical switch of claim 10, wherein the MEMS mirror includes a second driving mechanism to form a hybrid driving mechanism, wherein the second driving mechanism is electrostatic or piezoelectric.
